(19) United States
(12) Patent Application Publication
(10) Pub. No.: US 2022/0214674 A1
(43) Pub. Date: Jul. 7, 2022

(54) METHOD FOR MAINTAINING PREDICTIVE VALUE OF DEVICE THROUGH MULTIPLE CONTROL OUTPUT SIGNALS

(71) Applicant: ITS CO., LTD., Ulsan (KR)

(72) Inventor: Young Kyu Lee, Ulsan (KR)

(21) Appl. No.: 17/611,467

(22) PCT Filed: Jun. 4, 2020
(86) PCT No.: PCT/KR2020/007281

§ 371 Date: Nov. 15, 2021

(30) Foreign Application Priority Data
Jun. 25, 2019 (KR) 10-2019-0075820

(51) Int. Cl. G05B 23/02

(52) U.S. Cl. CPC G05B 23/0235; G05B 2223/04

(57) ABSTRACT

The present invention relates to a method for maintaining a predictive value of a device through multiple control output signals, and there is an effect that operating information of a device in a normal state and operating information of a device shown before a malfunction occurs are collected, a distrust value is set based on the collected information, a collection value depending on operating information of the device collected in real time is compared with the distrust value, and a warning is given when a condition that an abnormal symptom of the device is doubted is satisfied to guide repairing and replacement of the device to be performed at an appropriate time, thereby preventing enormous loss of money due to the malfunction of the device in advance.

### CROSS-REFERENCE TO RELATED APPLICATIONS

This application is the National Stage filing under 35 U.S.C. 371 of International Application No. PCT/KR2020/007281, filed on Jun. 4, 2020, which claims the benefit of K.R application No. 10-2019-0075820, filed on Jun. 25, 2019, the contents of which are all hereby incorporated by reference herein in their entirety.

### BACKGROUND

The present invention relates to a method for maintaining a predictive value of a device through multiple control output signals, and more particularly, to a method for maintaining a predictive value of a device through multiple control output signals, which collects operating information of a device in a normal state and operating information of a device shown before a malfunction occurs, sets a distrust value based on the collected information, compares a collection value depending on operating information of the device collected in real time with the distrust value, and gives a warning when a condition that an abnormal symptom of the device is doubted is satisfied to guide repairing and replacement of the device to be performed at an appropriate time, thereby preventing enormous loss of money due to the malfunction of the device in advance.

In general, in the case of various devices used for an automated process of a facility, a stable operation is very important.

For example, hundreds of devices are installed in the facilities of a large-scale production plant to continuously produce products while interlocking with each other. If any one of a plurality of devices has a malfunction, an enormous situation may occur in which an operation of the facility is stopped as a whole.

At this time, due to the occurrence of down time due to the malfunction of the device, it inevitably causes a huge loss caused by not only the repair cost of the device, but also operating costs and business effects wasted while the facility is stopped.

According to recent data from the Ministry of Employment and Labor and the Korea Occupational Safety and Management Agency, casualties caused by the annual industrial safety accidents were collected at the level of a total of 100,000, and a loss of 18 trillion won annually occurs when converting the casualties into cost.

As a method for avoiding such unexpected downtime costs, it is urgent to introduce a predictive maintenance system. There are efforts to improve the problem under the name of predictive maintenance, but it is necessary to develop higher predictive maintenance methods for more efficient predictive maintenance.

The present invention is proposed to solve all problems described above, and an object of the present invention is to provide a method for maintaining a predictive value of a device through multiple control output signals, which collects operating information of a device in a normal state and operating information of a device shown before a malfunction occurs, sets a distrust value based on the collected information, compares a collection value depending on operating information of the device collected in real time with the distrust value, and gives a warning when a condition that an abnormal symptom of the device is doubted is satisfied to guide repairing and replacement of the device to be performed at an appropriate time, thereby preventing enormous loss of money due to the malfunction of the device in advance.

Further, another object of the present invention is to provide a method for maintaining a predictive value of a device through multiple control output signals, which presents various detection conditions to effectively search for an abnormal symptom which occurs in the device and detects the device in an abnormal state when the detection condition is satisfied to precisely and effectively detect the abnormal symptom which occurs in the device, and securing excellent reliability for a detection result.

### SUMMARY

In order to achieve the object, a method for maintaining a predictive value of a device through multiple control output signals according to the present invention includes: a first base information collecting step (S10) of measuring and collecting at least one time intervals between a control output signal and another control output signal among multiple control output signals output by a control unit so that an operation of a device which operates by receiving multiple control output signals output by the control unit is performed in a normal state; a second base information collecting step (S20) of measuring and collecting at least one time intervals between the control output signal and other control output signals among multiple control output signals output by the control unit so that an operation of a device which operates by receiving multiple control output signals output by the control unit is performed in a state before a malfunction occurs, but collecting time intervals of at least one control output signal collected in the first base information collecting step (S10) and the same control output signal as other control output signals; a setting step (S30) of setting a distrust value for the time interval between the control output signals based on the time interval information collected in the first and second base information collecting steps (S10 and S20); and a detection step (S40) of collecting, time intervals between at least one control output signal collected in the first base information collecting step (S10) and the same control output signals as other control output signals among multiple control output signals output by the control unit so that the operation of the device is performed in real time, and detecting the device as in an abnormal state when the collected time interval value exceeds the distrust value set in the setting step (S30), in which when multiple time intervals between the control output signals are collected in the first and second base information collecting steps (S10 and S20), each of distrust values for multiple time intervals collected between the control output signals is set in the setting step (S30).

Further, the distrust value is set separately into the warning value and the risk value, but the warning value is set to a value smaller than the risk value, in the detection step (S40), when the time interval value between the control output signals collected by the device in real time exceeds the warning values of the distrust value, the device is recognized as in a warning state, and when the time interval value between the control output signals collected by the device in real time exceeds a risk value of the distrust value, the device is recognized as in a risk state at a higher level of a malfunction risk level of the device than the warning state.

Further, in the setting step (S30), a risk detection interval of a predetermined time including the operation of the device twice or more is set, and the number of times at which the time interval value between the control output signals transmitted to the device in the risk detection interval set in the detection step (S40) exceeds the warning value of the distrust value is counted, but when the counted number of times set in the detection step (S40) is detected to exceed the number of times set in the setting step (S30), the device is recognized as in the risk state.

Further, in the setting step (S30), time information capable of using the device is input, and in the detection step (S40), an average use time of the device for one day or a predetermined period is extracted and a use period during the device may be used at a current time is detected and provided based on the extracted average use time information.

As described above, according to the method for maintaining a predictive value of a device through multiple control output signals, there is an effect that operating information of a device in a normal state and operating information of a device shown before a malfunction occurs are collected, a distrust value is set based on the collected information, a collection value depending on operating information of the device collected in real time is compared with the distrust value, and a warning is given when a condition that an abnormal symptom of the device is doubted is satisfied to guide repairing and replacement of the device to be performed at an appropriate time, thereby preventing enormous loss of money due to the malfunction of the device in advance.

Further, there is an effect that various detection conditions are presented to effectively search for an abnormal symptom which occurs in the device and the device in an abnormal state is detected when the detection condition is satisfied to precisely and effectively detect the abnormal symptom which occurs in the device and secure excellent reliability for a detection result.

DESCRIPTION OF THE DRAWINGS

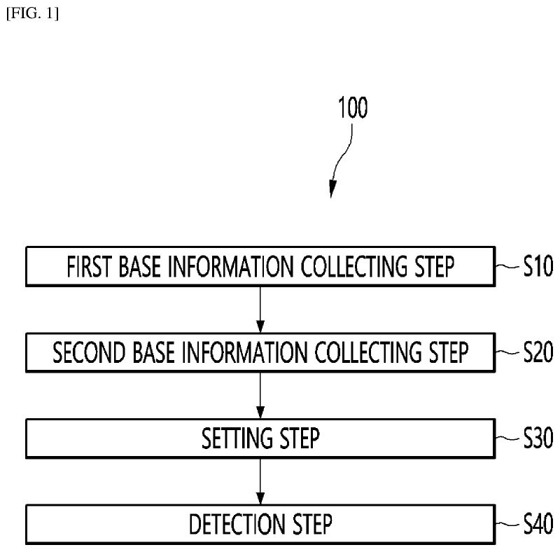

FIG. 1 is s a flowchart of a method for maintaining a predictive value of a device of multiple control output signals according to an exemplary embodiment of the present invention.

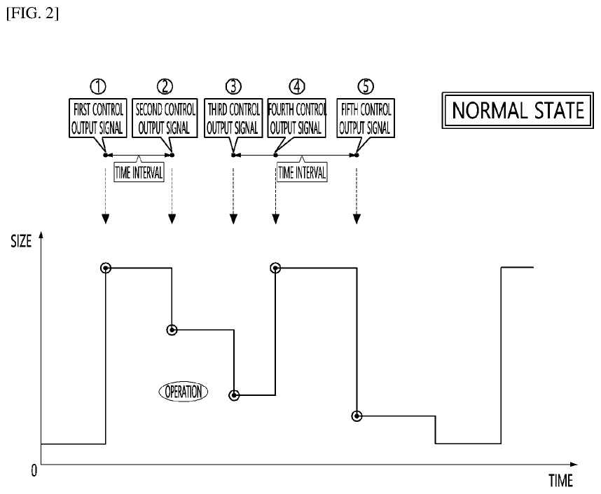

FIG. 2 is a diagram illustrating a first base information collecting step according to an exemplary embodiment of the present invention.

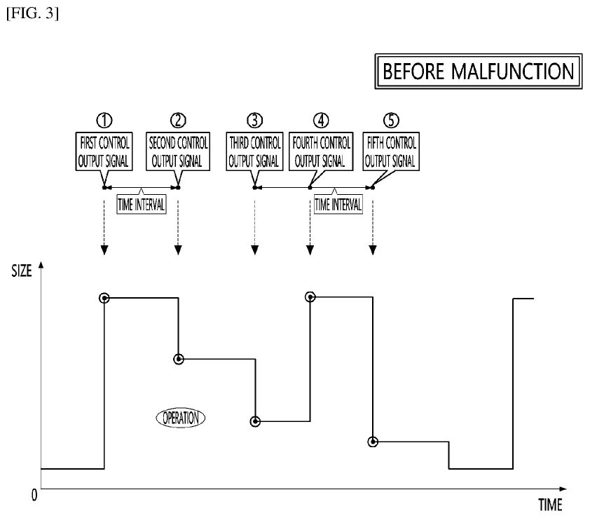

FIG. 3 is a diagram illustrating a second base information collecting step according to an exemplary embodiment of the present invention.

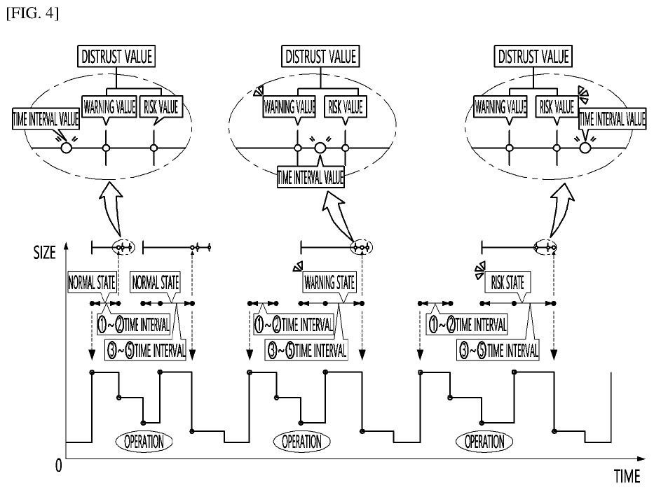

FIG. 4 is a diagram illustrating a detection step according to an exemplary embodiment of the present invention.

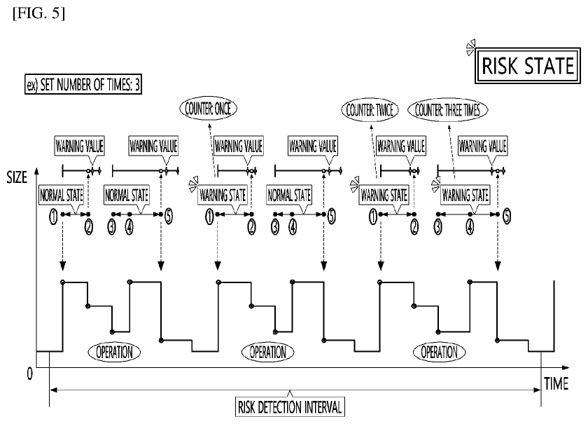

FIG. 5 is a diagram illustrating a method for recognizing a device state based on a counter number according to an exemplary embodiment of the present invention.

### DETAILED DESCRIPTION

Technology described below may have various modifications and various exemplary embodiments and specific exemplary embodiments will be illustrated in the drawings and described in detail. However, this does not limit the technology described below to specific exemplary embodiments, and it should be understood that the technology described below covers all the modifications, equivalents and replacements included within the idea and technical scope of the present disclosure.

Terms including first, second, A, B, and the like are used for describing various constituent elements, but the constituent elements are not limited by the terms and the terms are used only for distinguishing one constituent element from other constituent elements. For example, a first component may be referred to as a second component, and similarly, the second component may be referred to as the first component without departing from the scope of the technology to be described below. A term ‘and/or’ includes a combination of a plurality of associated disclosed items or any item of the plurality of associated disclosed items. For example, ‘A and/or B’ may be construed as ‘at least one of A and B’.

It is to be understood that the singular expression encompasses a plurality of expressions unless the context clearly dictates otherwise and it should be understood that term “include” or the likeindicates that a feature, a number, a step, an operation, a component, a part or the combination thereof described in the specification is present, but does not exclude a possibility of presence or addition of one or more other features, numbers, steps, operations, components, parts or combinations thereof.

Prior to a detailed description for drawings, it will be apparent that classifying components in the present specification is just classifying the components for each main function of which each component takes charge. That is, two or more components to be described below may be combined into one component or one component may be divided into two or more for each more subdivided function and provided. In addition, each of the components to be described below may additionally perform some or all of the functions that are handled by other components in addition to main functions that the corresponding component is responsible for, and some of the main functions of which the respective components take charge may be exclusively carried out by other components.

Further, in performing a method or an operating method, respective processes constituting the method may be performed differently from a described order unless a specific order is disclosed clearly in terms of a context. That is, the respective processes may be performed similarly to the specified order, performed substantially simultaneously, and performed in an opposite order.

A method for maintaining a predictive value of a device through multiple control output signals according to a preferred exemplary embodiment of the present invention will be described in detail with reference to the accompanying drawings. The detailed description of publicly-known function and configuration that may make the gist of the present invention unnecessarily ambiguous will be omitted.

FIG. 1 is s a flowchart of a method for maintaining a predictive value of a device of multiple control output signals according to an exemplary embodiment of the present invention.

As illustrated in FIG. 1, the method for maintaining a predictive value of a device through multiple control output signals according to an exemplary embodiment of the present invention includes a first base information collecting step (S10), a second base information collecting step (S20), a setting step (S30), and a detecting step (S40).

The first base information collecting step (S10) is a step of measuring and collecting at least one time intervals between a control output signal and another control output signal among multiple control output signals output by a control unit so that an operation of a device which operates by receiving multiple control output signals output by the control unit is performed in a normal state.

In general, the device performs the operation by receiving the control output signal from the control unit in order to perform the operation, and as an example, a device such as a robot arm constituted by multiple driving units and transporting a material operates while receiving multiple control output signals from the control unit and controlling each driving unit in order to perform one operation of transporting the material, and an operation process of the device is illustrated in FIG. 2.

FIG. 2 is a diagram illustrating a first base information collecting step according to an exemplary embodiment of the present invention.

A waveform illustrated in FIG. 2 shows an energy (power) value consumed while the device performs the operation according to a flow of a time for convenience of description.

That is, in the first base information collecting step (S10), the device collects a time interval between one or more control output signals among five control output signals transmitted for performing an operation performed by the device in a normal state, and as an example, determines five control output signals as a first control output signal, . . . , a fifth control output signal sequentially, and measures and collects a time interval between the first control output signal and the second control output signal and a time interval between the third control output signal and the fifth control output signal to collect time interval information between a total of two control output signals.

The time interval information between two control output signals becomes a basis of a distrust value set to detect an abnormal symptom of the device in the setting step (S30) to be described below.

Herein, the number of control output signals transmitted to the device to control the operation of the device is determined as 5 and collecting the time interval information between two control output signals among the control output signals is described as an example, and it is not of course that the present invention is limited to the number.

FIG. 3 is a diagram illustrating a second base information collecting step according to an exemplary embodiment of the present invention.

As illustrated in FIG. 3, the second base information collecting step (S20) is a step of measuring and collecting at least one time intervals between the control output signal and other control output signals among multiple control output signals output by the control unit so that an operation of a device which operates by receiving multiple control output signals output by the control unit is performed in a state before a malfunction occurs, but collecting time intervals of at least one control output signal collected in the first base information collecting step (S10) and the same control output signal as other control output signals.

That is, in the second base information collecting step (S20), time interval information between two control output signals (first and second control output signals and third and fifth control output signals) is collected as in the first base information collecting step (S10), and the collected time interval information between the control output signals becomes a basis of a distrust value set to detect the abnormal symptom of the device in the setting step (S30), of course.

Here, it may be known that the time interval between the control output signals output by the control unit in order to control the operation of the device illustrated in FIG. 3 is longer than the time interval between the control output signals output by the control unit in order to control the operation of the device illustrated in FIG. 2, and this may cause guessing that a time required for the operation performed by the device gradually increases as the state of the device is poor, and as a result, the time between the control output signals output by the control unit is also naturally increased.

The setting step (S30) is a step of setting a distrust value for the time interval between the control output signals based on the time interval information collected in the first and second base information collecting steps (S10 and S20).

That is, since time interval information between a total of two control output signals is collected in the first and second base information collecting steps (S10 and S20), the distrust value is set for each time interval between two control output signals. Accordingly, in the setting step (S30), a total of two distrust values are set.

Here, the distrust value is set based on values in which the time interval value between the control output signals is abnormally changed (increased) before the malfunction of the device occurs based on the time information collected for a long time in the first and second base information collecting steps (S10 and S20).

The distrust value of the method 100 for maintaining a predictive value of a device through a control output signal according to the present invention is set separately as a warning value and a risk value, but it is not of course that the distrust value is described by limiting to such a value.

Here, the warning value is set to a value smaller than the risk value, and the warning and disk values will be described in detail in the detection step (S40) to be described below.

FIG. 4 is a diagram illustrating a detection step according to an exemplary embodiment of the present invention.

The detection step (S40) is a step of collecting, time intervals between at least one control output signal collected in the first base information collecting step (S10) and the same control output signals as other control output signals among multiple control output signals output by the control unit so that the operation of the device is performed in real time, and detecting the device as in an abnormal state when the collected time interval value exceeds the distrust value set in the setting step (S30).

That is, as illustrated in FIG. 4, in the detection step (S40), among the control output signals output by the control unit in order to control the operation of the device in real time, each of the time interval between the first control output signal and the second output signal, and the time interval between the third control output signal and the fifth control output signal is measured and collected, and each of the time intervals between the control output signals is compared with the distrust value to detect the state of the device as follows.

When the time interval value between the first and second control output signals does not exceed a warning value or a risk value of the distrust value for the time interval between the first and second control output signals and when the time interval value between the third and fifth control output signals does not exceed a warning value or a risk value of the distrust value for the time interval between the third and fifth control output signals, the device is detected as in the normal state, when any one or both of the time interval value between the first and second control output signals or the time interval value between the third and fifth control output signals exceeds the warning value of the distrust value, the device is detected as in the warning state, and when any one or both of the time interval value between the first and second control output signals or the time interval value between the third and fifth control output signals exceeds the risk value of the distrust value, the device is detected as in the risk state.

Here, the warning value indicates a malfunction risk level of a lower level than the risk value, and the warning state of the device is a degree at which an interest and a caution of the device are requested, and the risk state of the device may be regarded as a degree at which repairing, checking, or replacement of the device is requested.

Accordingly, the abnormal symptom is detected in advance based on the state of the device detected in real time in the detection step (S40) to guide economical loss which may occur due to a stop of an overall operation of the facility due to a sudden malfunction of the device from being prevented in advance.

Further, in the setting step (S30), a risk detection interval of a predetermined time including the operation of the device twice or more is set, and the number of times at which the time interval value between the control output signals transmitted to the device in the risk detection interval set in the detection step (S40) exceeds the warning value of the distrust value is counted, but when the counted number of times set in the setting step (S40) is detected to exceed the number of times set in the setting step (S30), the device is recognized as in the risk state.

FIG. 5 is a diagram illustrating a method for recognizing a device state based on a counter number according to an exemplary embodiment of the present invention.

As illustrated in FIG. 5, in the setting step (S30), an interval including three operations of the device is set as the risk detection interval, and when the set number of times is set to three, when the time interval value between control output signals transmitted to the device to perform operation of the device in real time in the risk detection interval in the detection step (S40) exceeds the warning value of the distrust value, the number of times is counted, but when the counted number of times is counted to exceed three set in the setting step (S30), the device is recognized as in the risk state to guide predictive value maintenance through precise checking or replacement of the device.

Meanwhile, in the setting step (S30), time information capable of using the device is input and set, and in the detection step (S40), an average use time of the device for one day or a predetermined period is extracted and a use period during the device may be used at a current time is detected and provided based on the extracted average use time information.

In general, the device has an average use life-span, and when the average use life-span is converted into the time and set in the setting step (S30), since an average usage amount of the device may be measured and a period (time) when the device may be used may be detected and provided to a manager, the manager may clearly recognize an approximate use life-span of the device to efficiently design a long plan for replacement of the device, etc., thereby guiding the facility to be stably operated and managed.

According to the method 100 for maintaining a predictive value of a device through multiple control output signals, which detects the abnormal symptom of the device by such a process, there is an effect that operating information of a device in a normal state and operating information of a device shown before a malfunction occurs are collected, a distrust value is set based on the collected information, a collection value depending on operating information of the device collected in real time is compared with the distrust value, and a warning is given when a condition that an abnormal symptom of the device is doubted is satisfied to guide repairing and replacement of the device to be performed at an appropriate time, thereby preventing enormous loss of money due to the malfunction of the device in advance.

Further, there is an effect that various detection conditions are presented to effectively search for an abnormal symptom which occurs in the device and the device in an abnormal state is detected when the detection condition is satisfied to precisely and effectively detect the abnormal symptom which occurs in the device and secure excellent reliability for a detection result.

The method 100 for maintaining a predictive value of a device through multiple control output signals according to the present invention is described based on the control output signal output to the device by the control unit, but even though the technology is applied based on a control input signal output from the control unit and input into the device, it is of course that the same effect may be expected.

The present invention has been described with reference to the exemplary embodiment illustrated in the accompanying drawings and is just exemplary and is not limited to the above-described exemplary embodiments, and it will be appreciated by those skilled in the art that various modifications and exemplary embodiments equivalent thereto can be made therefrom. In addition, modifications by those skilled in the art can be made without departing from the scope of the present invention. Therefore, the scope of the claims in the present invention will not be defined within the scope of the detailed description but will be defined by the following claims and the technical spirit thereof.

The exemplary embodiments of the present disclosure may be implemented by hardware, firmware, software, or combinations thereof. In the case of implementation by hardware, the exemplary embodiment described herein may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Further, in the case of implementation by firmware or software, the exemplary embodiment of the present invention may be implemented in the form of a module, a procedure, a function, and the like to perform the functions or operations described above and recorded in recording media readable by various computer means. Herein, the recording medium may include singly a program command, a data file, or a data structure, or a combination thereof. The program command recorded in the recording medium may be specially designed and configured for the present invention or may be publicly known to and used by those skilled in the computer software field. Examples of the computer-readable recording medium include magnetic media such as a hard disk, a floppy disk, and a magnetic tape, optical media such as a compact disk read only memory (CD-ROM) and a digital video disk (DVD), magneto-optical media such as a floptical disk, and a hardware device which is specifically configured to store and execute the program command such as a ROM, a RAM, and a flash memory. An example of the program command includes a high-level language code executable by a computer by using an interpreter and the like, as well as a machine language code created by a compiler. The hardware devices may be configured to operate as one or more software modules in order to perform the operation of the present invention, and an opposite situation thereof is available.

In addition, an apparatus or terminal according to the present invention may be driven by commands that cause one or more processors to perform the functions and processes described above. The commands may include, for example, interpreted commands such as script commands, such as JavaScript or ECMAScript commands, executable codes or other commands stored in computer readable media. Further, the apparatus according to the present invention may be implemented in a distributed manner across a network, such as a server farm, or may be implemented in a single computer device.

In addition, a computer program (also known as a program, software, software application, script or code) that is embedded in the apparatus according to the present invention and which implements the method according to the present invention may be prepared in any format of a compiled or interpreted language or a programming language including a priori or procedural language and may be deployed in any format including standalone programs or modules, components, subroutines, or other units suitable for use in a computer environment. The computer program does not particularly correspond to a file in a file system. The program may be stored in a single file provided to a requested program, in multiple interactive files (e.g., a file storing one or more modules, subprograms, or portions of code), or in a part (e.g., one or more scripts stored in a markup language document) of a file storing another program or data. The computer program may be positioned in one site or distributed throughout a plurality of sites and extended to be executed on multiple computers interconnected by a communication network or one computer.

Although the drawings have been described for the sake of convenience of explanation, it is also possible to design a new exemplary embodiment to be implemented by merging the exemplary embodiments described in each drawing. Further, configurations and methods of the described exemplary embodiments may not be limitedly applied to the aforementioned present invention, but all or some of the respective exemplary embodiments may be selectively combined and configured so as to be variously modified.

Further, while the exemplary embodiments of the present invention have been illustrated and described above, the present invention is not limited to the aforementioned specific exemplary embodiments, various modifications may be made by a person with ordinary skill in the technical field to which the present invention pertains without departing from the subject matters of the present invention that are claimed in the claims, and these modifications should not be appreciated individually from the technical spirit or prospect of the present invention.

The present invention may be applied to various device inspection technical fields.

I/we claim:

1. A method for maintaining a predictive value of a device through multiple control output signals, the method comprising:
a first base information collecting step of measuring and collecting at least one time intervals between a control output signal and another control output signal among multiple control output signals output by a control unit so that an operation of a device which operates by receiving multiple control output signals output by the control unit is performed in a normal state;
a second base information collecting step of measuring and collecting at least one time intervals between the control output signal and other control output signals among the multiple control output signals output by the control unit so that the operation of the device which operates by receiving the multiple control output signals output by the control unit is performed in a state before a malfunction occurs, but collecting time intervals of at least one control output signal collected in the first base information collecting step and the same control output signal as other control output signals;
a setting step of setting a distrust value for the time interval between the control output signals based on the time interval information collected in the first and second base information collecting steps; and
a detection step of collecting, time intervals between the at least one control output signal collected in the first base information collecting step and the same control output signals as other control output signals among the multiple control output signals output by the control unit so that the operation of the device is performed in real time, and detecting the device as in an abnormal state when the collected time interval value exceeds the distrust value set in the setting step,
wherein, when multiple time intervals between the control output signals are collected in the first and second base information collecting steps, each of the distrust values for the multiple time intervals between the control output signals is set in the setting step.

2. The method for maintaining a predictive value of a device through multiple control output signals of claim 1, wherein the distrust value is set separately into a warning value and a risk value, but the warning value is set to a value smaller than the risk value,
in the detection step, when the time interval value between the control output signals collected by the device in real time exceeds the warning values of the distrust value, the device is recognized as in a warning state, and
when the time interval value between the control output signals collected by the device in real time exceeds the risk value of the distrust value, the device is recognized as in a risk state at a higher level of a malfunction risk level of the device than the warning state.

3. The method for maintaining a predictive value of a device through multiple control output signals of claim 2, wherein in the setting step, a risk detection interval of a predetermined time including the operation of the device twice or more is set, and
the number of times at which the time interval value between the control output signals transmitted to the device in the risk detection interval set in the detection step exceeds the warning value of the distrust value is counted, but when the counted number of times set in the detection step is detected to exceed the number of times set in the setting step, the device is recognized as in the risk state.

4. The method for maintaining a predictive value of a device through multiple control output signals of claim 1, wherein in the setting step, time information capable of using the device is input, and
in the detection step, an average use time of the device for one day or a predetermined period is extracted and a use period during the device may be used at a current time is detected and provided based on the extracted average use time information.
